(19) United States
(12) Patent Application Publication
(10) Pub. No.: US 2010/0321928 A1
(43) Pub. Date: Dec. 23, 2010

(54) LED EMITTING APPARATUS FOR SHOE

(76) Inventor: STEVE CHENGWEN YANG, Hacienda Heights, CA (US)

Correspondence Address: Chien-Hui Su, P. O. Box 70-121 Taichung, Taichung City, 40899, TW

(21) Appl. No.: 12/487,641

(22) Filed: Jun. 18, 2009

(51) Int. Cl. F21V 21/08

(52) U.S. Cl. 362/103

(57) ABSTRACT

A LED emitting apparatus for shoe includes a shoe body having an upper shoe surface, a power supply, and a switch connected to the power supply. The power supply is electrically connected to at least one light source mounted to the shoe body. The emitting apparatus further includes an emitting assembly disposed on the upper shoe surface. The emitting assembly includes a light guide layer and a thin film. The light guide layer and the thin film are pervious to light. A plurality of optical fibres densely and uniformly dispose in the light guide layer. The optical fibres carry the emitted light therealong. Therefore, the emitting assembly is uniformly illuminated for decorating the shoe and being a hazard light.

### BACKGROUND OF THE INVENTION

1. Field of the Invention

The present invention relates to a LED emitting apparatus for shoe, and more particularly to an apparatus for decorating the shoe and being a hazard light.

2. Description of Related Art

A conventional lighted shoe apparatus in accordance with the prior art comprises a shoe body, a shoe sole connected to the shoe body, a plurality of light emitting elements mounted to the shoe sole for lighting in a sequence, a battery device mounted to the shoe sole and electrically connected to the light emitting elements for supplying electricity to the light emitting elements, and a switch mounted to the shoe body for controllably connecting the light emitting elements. The shoe sole is made of transparent material for transmitting light. The light emitting elements are assembled adjacent the outside edge of the shoe sole in series. When a wearer turns on the lighted shoe apparatus, the lighted shoe apparatus is attractive and makes the wearer safe in a dark environment.

However, the prior art suffered from several disadvantages. Due to the disposition of the light emitting elements and the lack of a diffusing portion, the light emitted from the light emitting elements is not uniform. The lighted shoe apparatus shows the colour of the light emitted from the light emitting elements, but it does not have any designed pattern to provide a decorative effect.

The present invention has arisen to mitigate and/or obviate the disadvantages of the conventional lighted shoe apparatus.

### SUMMARY OF THE INVENTION

The main objective of the present invention is to provide an improved LED emitting apparatus for shoe.

To achieve the objective, the LED emitting apparatus for shoe in accordance with the present invention includes a shoe body having an upper shoe surface formed thereon, a power supply mounted to the shoe body, and a switch attached to the upper shoe surface and connected to the power supply for manually controlling ON/OFF of the power supply. The power supply is electrically connected to at least one light source and a controlling chip which both are mounted to the shoe body. The power supply provides electricity to the at least one light source. The at least one light source is small-size and colour-tunable. The controlling chip is connected electrically to the at least one light source for controlling output of the at least one light source.

Moreover, the LED emitting apparatus for shoe further comprises an emitting assembly disposed on the upper shoe surface. The emitting assembly includes a light guide layer fixed on the upper shoe surface and a thin film laminated on the light guide layer for protecting the light guide layer from dust and scratches. The light guide layer and the thin film are pervious to light and flexible for being easily laminated on the shoe surface. In addition, the light guide layer comprises a plurality of optical fibres densely and uniformly disposed therein. The optical fibres are made of transparent and flexible material for receiving light from the at least one light source and carrying light therealong for transmitting light outwardly. The thin film is made of metal, rubber, plastic or cloth, and may be made by the weaving method.

When the light emitted from the at least one light source is coupled into the optical fibres received inside the light guide layer, the light is conducted uniformly through the light guide layer and is transmitted toward the thin film. Therefore, the emitting assembly is uniformly illuminated.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a preferred embodiment of the LED emitting apparatus for shoe;

FIG. 2 is a side view of the preferred embodiment of the LED emitting apparatus for shoe;

FIG. 2a is a circuit block diagram of the preferred embodiment of the LED emitting apparatus for shoe;

FIG. 2b is a partial enlarged cross-sectional view of an emitting assembly laminated on an upper shoe surface;

FIG. 3 is a side perspective view of a preferred embodiment of the LED emitting apparatus for shoe as the emitting assembly is illuminating; and

FIG. 4 is a side view of a second embodiment of the LED emitting apparatus for shoe with a different decorative pattern.

### DETAILED DESCRIPTION OF THE INVENTION

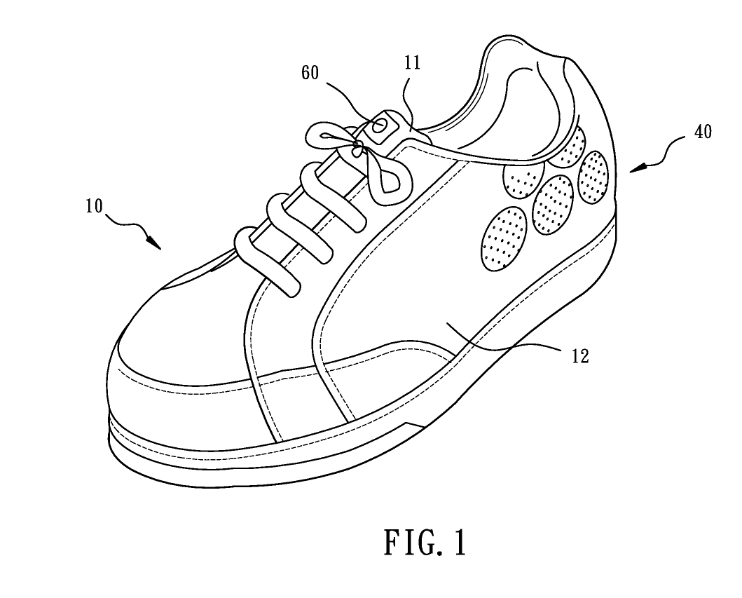

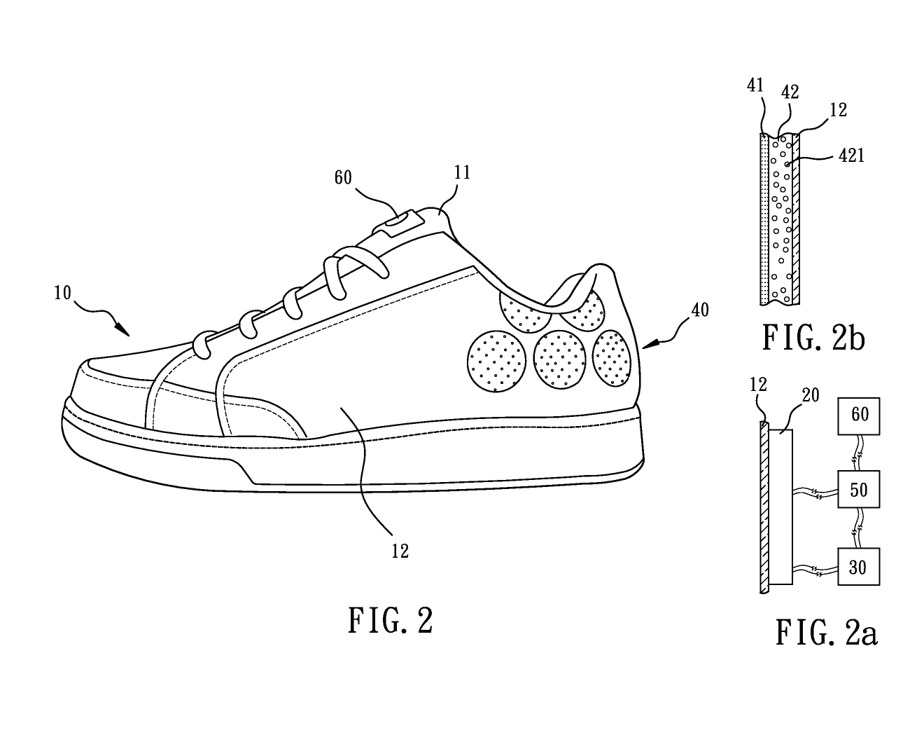

Referring to the drawings and initially to FIGS. 1-2, a LED emitting apparatus for shoe in accordance with a preferred embodiment of the present invention comprises a shoe body 10 having an upper shoe surface 12 formed thereon. The upper shoe surface 12 has a tongue 11 defined thereof.

As shown in FIG. 2a, the LED emitting apparatus for shoe further comprises a switch 60 which is attached to the tongue 11. The switch 60 is electrically connected to a power supply 50 for manually controlling ON/OFF of the power supply 50. The power supply 50 is electrically connected to at least one light source 20 and a controlling chip 30 which both are mounted to the shoe body 10. The power supply 50 provides electricity to the at least one light source 20 such that the at least one light source 20 emits light outwardly. The at least one light source 20 is small-size and colour-tunable for being easily hid underneath the upper shoe surface 12 and emitting light in varied colours respectively. The at least one light source 20 may be a light emitting diode (LED), a laser diode or the like. The controlling chip 30 is connected electrically to the at least one light source 20 for controlling output of the at least one light source 20.

Moreover, as shown in FIG. 2b, the LED emitting apparatus for shoe further comprises an emitting assembly 40 disposed on the upper shoe surface 12. The emitting assembly 40 includes a light guide layer 42 fixed on the upper shoe surface 12 and a thin film 41 laminated on the light guide layer 42 for protecting the light guide layer 42 from dust and scratches. The light guide layer 42 and the thin film 41 are flexible for being easily laminated on the upper shoe surface 12. The light guide layer 42 and the thin film 41 are pervious to light for transmitting the light outwardly. In addition, the thin film 41 is made of metal, rubber, plastic, or cloth, and may be made by the weaving method.

Furthermore, the light guide layer 42 comprises a plurality of optical fibres 421 densely and uniformly disposed therein. The at least one light source 20 is placed adjacent the optical fibres 421 so that the emitted light is just coupled into the optical fibres 421. The optical fibres 421 are made of transparent and flexible material for transmitting the light emitted from the at least one light source 20 and being easily received in the light guide layer 42 respectively.

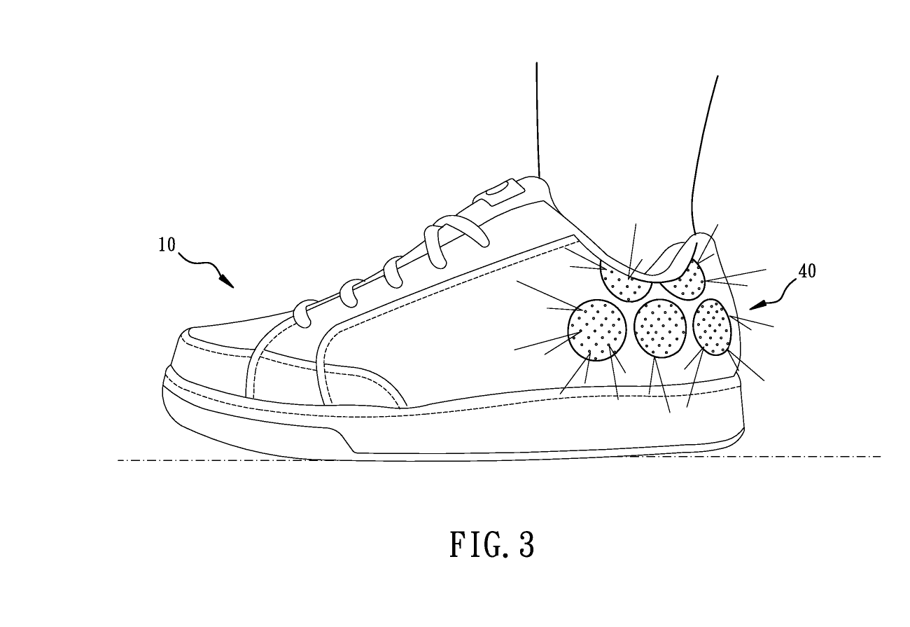

As shown in FIG. 3, when a wearer manually presses the switch 60 on, the power supply 50 provides electricity to the controlling chip 30 and the at least one light source 20. By pressing the switch 60 at different times, the controlling chip 30 is set to change to the corresponding output of the at least one light source 20, such as blinking, single colour changing or multi-colours changing. The light emitted from the at least one light source 20 is coupled into the optical fibres 421 received inside the light guide layer 42 and carried along the optical fires 421. Accordingly the light is conducted uniformly through the light guide layer 42 and is transmitted toward the thin film 41. Therefore, the emitting assembly 40 is uniformly illuminated so as to decorate the shoe body 10 and be hazard light in a dark environment for protecting the wearer from danger.

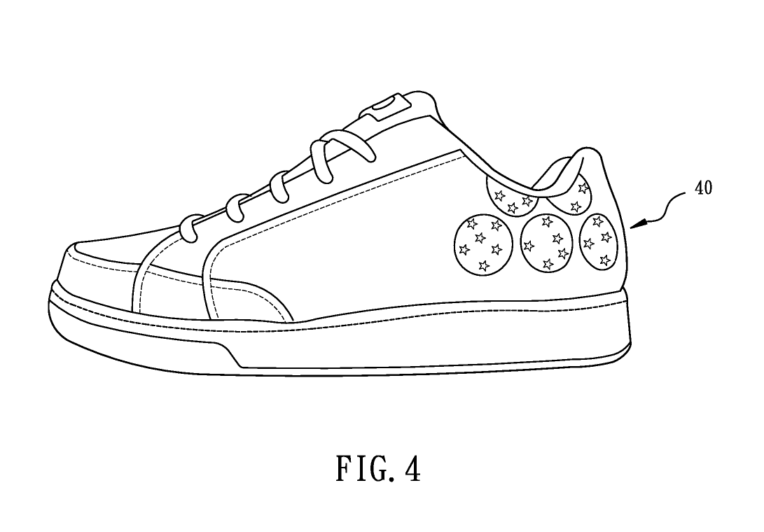

FIG. 4 shows a second embodiment of a LED emitting apparatus for shoe according to the present invention. The elements and effects of the second embodiment which are the same with the preferred embodiment are not described, only the differences are described. The emitting assembly 40 has a different decorative pattern defined thereon for beautifying the shoe body 10.

Although the invention has been explained in relation to its preferred embodiment, it is to be understood that many other possible modifications and variations can be made without departing from the spirit and scope of the invention as hereinafter claimed.

What is claimed is:

1. A LED emitting apparatus for shoe comprising:
a shoe body having an upper shoe surface formed thereon;
at least one light source mounted to the shoe body;
a controlling chip mounted to the shoe body and connected electrically to the at least one light source for controlling output of the at least one light source; and
an emitting assembly disposed on the upper shoe surface, the emitting assembly comprising:
a light guide layer fixed on the upper shoe surface and connected to the at least one light source for adapting to carry light therein; and
a thin film laminated on the light guide layer for protecting the light guide layer from dust and scratches,
wherein the light guide layer and the thin film are pervious to light; when the at least one light source emits light into the light guide layer, the light emitted from the at least one light source is conducted uniformly through the light guide layer and the light is transmitted toward the thin film such that the emitting assembly is illuminated uniformly.

2. The LED emitting apparatus for shoe as claimed in claim 1 further comprising a power supply mounted to the shoe body, the power supply electrically connected to the controlling chip and the at least one light source, wherein the power supply provides electricity to the at least one light source.

3. The LED emitting apparatus for shoe as claimed in claim 1, wherein the light guide layer comprising a plurality of optical fibres densely and uniformly disposed therein, the optical fibres made of transparent and flexible material, wherein the optical fibres receive light from the at least one light source and carry light therealong.

4. The LED emitting apparatus for shoe as claimed in claim 1, wherein the at least one light source is small-sized and colour-tunable.

5. The LED emitting apparatus for shoe as claimed in claim 1, wherein the light guide layer and the thin film are flexible for being laminated easily on the shoe surface.

6. The LED emitting apparatus for shoe as claimed in claim 1, wherein the thin film is made of metal.

7. The LED emitting apparatus for shoe as claimed in claim 1, wherein the thin film is made of rubber.

8. The LED emitting apparatus for shoe as claimed in claim 1, wherein the thin film is made of plastic.

9. The LED emitting apparatus for shoe as claimed in claim 1, wherein the thin film is made of cloth.

10. The LED emitting apparatus for shoe as claimed in claim 1, wherein the thin film is made by weaving.

11. The LED emitting apparatus for shoe as claimed in claim 2 further comprising a switch attached to the upper shoe surface and electrically connected to the power supply for controlling ON/OFF of the power supply.
